(19) United States
(12) Patent Application Publication
(10) Pub. No.: US 2025/0142306 A1
(43) Pub. Date: May 1, 2025

(54) METHOD AND APPARATUS FOR MANAGING A PULL NOTIFICATION MESSAGE TRIGGER IN A SEAL NOTIFICATION MANAGEMENT SERVICE

(71) Applicant: SAMSUNG ELECTRONICS CO., LTD., Suwon-si (KR)

(72) Inventor: Vijay SANGAMESHWARA, Bangalore (IN)

(21) Appl. No.: 18/929,325

(22) Filed: Oct. 28, 2024

(30) Foreign Application Priority Data
Oct. 30, 2023 (IN) 202341073934
Oct. 7, 2024 (IN) 202341073934

(51) Int. Cl. H04W 4/50

(52) U.S. Cl. CPC H04W 4/50

(57) ABSTRACT

Embodiments of the disclosure describe a method for managing a PULL notification message trigger procedure to enable a service enabler architecture layer (SEAL) notification management client (SNM-C) 200 to share a pull notification message trigger indication to a SEAL notification management server (SNM-S) 300. The updates to the existing create notification channel procedures to manage a pull notification message triggers (PNMT) in SEAL notification management services are performed. Further, a new pull notification message trigger information field represents the SNM-C 200 indication to support such application triggers to initiate the pull notification message procedure. The method for the SNM-C 200 to encode the pull notification message trigger information field as part of the create notification channel request information element sent in a HTTP request body to the SNM-S 300.

### CROSS-REFERENCE TO RELATED APPLICATIONS

This application is based on and claims priority under 35 U.S.C. § 119 to Indian Patent Application number 202341073934 filed on Oct. 30, 2023, and Indian Patent Application number 202341073934 filed on Oct. 7, 2024, in the Indian Intellectual Property Office, the disclosure of which are incorporated by reference herein in their entirety.

### BACKGROUND

### 1. Field

The present disclosure generally relates to a service enabler architecture layer (SEAL) notification management, and more particularly the present disclosure relates to a method to manage a pull notification message trigger in the SEAL notification management service.

### 2. Description of Related Art

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This summary is provided to introduce a selection of concepts, in a simplified format, that are further described in the detailed description of the disclosure. This summary is neither intended to identify key or essential inventive concepts of the disclosure nor is it intended for determining the scope of the disclosure.

According to embodiments of the present disclosure, a method performed by a service enabler architecture layer (SEAL) notification management (SNM) client (SNM-C) in a communication system is provided, the method comprising: receiving, from a vertical application layer (VAL) service, a request to receive at least one notification via a notification channel; transmitting, to an SNM server (SNM-S), a hypertext transfer protocol (HTTP) POST request comprising a create notification channel request message; and receiving, from the SNM-S, an HTTP 200 (OK) response, wherein the create notification channel request message comprises information on capability to support application trigger to initiate pull notification message procedure.

According to embodiments of the present disclosure, the method further comprises:
creating the notification channel by transmitting the HTTP POST request to the SNM-S; and transmitting, to the VAL service, information on a successful creation of the notification channel, wherein the HTTP POST request comprises at least one of information on uniform resource identifier (URI) of the SNM-S, information on a host header with a public user identity of the SNM-S, information on an authorization header field with a bearer authentication scheme, or information on a content-type header field.

According to embodiments of the present disclosure, wherein the HTTP 200 (OK) response comprises a create notification channel response message,
wherein the create notification channel response message comprises information on capability to send the application trigger to the SNM-C to initiate the pull notification message procedure, and
wherein the information on the capability to send the application trigger to the SNM-C to initiate the pull notification message procedure is stored in the SNM-S for future usage to send triggers to the SNM-C for outstanding notification messages received from a VAL server.

According to embodiments of the present disclosure, wherein the application trigger enables the SNM-C to pull notification messages from the SNM-S only when outstanding notifications are available at the SNM-S, and wherein the SNM-S utilizes at least one application triggering service or at least one device triggering service provided by a core network via network exposure function (NEF) or service capability exposure function (SCEF).

According to embodiments of the present disclosure, a method performed by a service enabler architecture layer (SEAL) notification management (SNM) server (SNM-S) in a communication system is provided, the method comprising: receiving, from an SNM client (SNM-C), a hypertext transfer protocol (HTTP) POST request comprising a create notification channel request message; and transmitting, to the SNM-C, an HTTP 200 (OK) response, wherein the create notification channel request message comprises information on capability to support application trigger to initiate pull notification message procedure.

According to embodiments of the present disclosure, a service enabler architecture layer (SEAL) notification management (SNM) client (SNM-C) in a communication system is provided, the SNM-C comprising: a transceiver; and at least one processor coupled with the transceiver and configured to: receive, from a vertical application layer (VAL) service, a request to receive at least one notification via a notification channel, transmit, to an SNM server (SNM-S), a hypertext transfer protocol (HTTP) POST request comprising a create notification channel request message, and receive, from the SNM-S, an HTTP 200 (OK) response, wherein the create notification channel request message comprises information on capability to support application trigger to initiate pull notification message procedure.

According to embodiments of the present disclosure, a service enabler architecture layer (SEAL) notification management (SNM) server (SNM-S) in a communication system is provided, the SNM-S comprising: a transceiver; and at least one processor coupled with the transceiver and configured to: receive, from an SNM client (SNM-C), a hypertext transfer protocol (HTTP) POST request comprising a create notification channel request message, and transmit, to the SNM-C, an HTTP 200 (OK) response, wherein the create notification channel request message comprises information on capability to support application trigger to initiate pull notification message procedure.

In one or more embodiments, the present disclosure relates to a method to create a notification channel procedure to enable a service enabler architecture layer (SEAL) Notification management client (SNM-C) to share a pull notification message trigger indication to a SEAL Notification management server (SNM-S). The updates to an existing create notification channel procedures to manage a pull notification message triggers (PNMT) in SEAL Notification management services are performed. Further, a new PNMT information field represents a SNM-C indication to support such application triggers to initiate the pull notification message procedure. The method for the SNM-C to encode the PNMT information field as part of the create notification channel request information element sent in a hypertext transfer protocol (HTTP) request body to the SNM-S.

In one or more embodiments, the method for the SNM-S to decode the pull notification message trigger information field received as part of the create notification channel request in the HTTP request body from the SNM-C. So, the method discloses initiating the HTTP request from the SNM-C to the pull notification messages only upon receiving the application trigger from the SNM-S thereby reducing the resource consumption in case of the HTTP long PULL requests.

So, as per the current specification of 3GPP TS 24.542 (SEAL notification management), there are resources consumed to maintain a Transmission Control Protocol (TCP) channel used by a HTTP long polling request initiated to the pull notification messages as part of the PULL notification channel type. The method addresses the issue by providing the pull notification message trigger indication shared by the SNM-C as part of the create notification channel procedure. The SNM-S may initiate this application trigger towards the SNM-C upon receiving notification messages from a vertical application layer (VAL) server addressed to the SNM-C.

According to one embodiment of the present disclosure, a method for managing a PULL notification message trigger in a service enabler architecture layer (SEAL) notification management (SNM) service is disclosed herein. The method includes receiving, by a service notification management client (SNM-C), a request from one or more vertical application layer (VAL) services to receive one or more notifications via the notification channel. The method further includes creating, upon receiving the request, by the SNM-C, the notification channel with PULL notification message trigger by transmitting a hypertext transfer protocol (HTTP) POST request to a service notification management server (SNM-S). The HTTP POST request comprises at least one of a request uniform resource identifier (URI) to a URI of the SNM-S, a host header with a public user identity of the SNM-S, an authorization header field with a bearer authentication scheme, a content-type header field, and a PULL notification message triggers support indication.

According to another embodiment of the present disclosure, a method for creating a notification channel with PULL notification message trigger in a service enabler architecture layer (SEAL) notification management (SNM) service is disclosed herein. The method includes receiving, by a service notification management server (SNM-S), a hypertext transfer protocol (HTTP) POST request from a service notification management client (SNM-C) to create the notification channel. The method further includes detecting, based on the received HTTP POST request, by the SNM-S, that the channel type is a PULL notification channel, and a value of a PULL notification message triggers support indication is assigned as true. The method further includes determining, by the SNM-S, whether the SNM-S supports sending a PULL notification message trigger to the SNM-C to initiate a PULL notification message procedure. The method further includes sending, by the SNM-S, a PULL trigger support indication, in an HTTP 200 (OK) message, to the SNM-C, wherein the HTTP 200 (OK) message comprises one or more server-side parameters to create the notification channel with the PULL notification message trigger.

According to another embodiment of the present disclosure, a service notification management client (SNM-C) for creating a notification channel with PULL notification message trigger in a service enabler architecture layer (SEAL) notification management (SNM) service is disclosed herein. The SNM-C includes a memory, a processor, and a communicator. The processor is configured to receive a request from one or more vertical application layer (VAL) services to receive one or more notifications via the notification channel. The processor is further configured to create, upon receiving the request, by the SNM-C, the notification channel by transmitting a hypertext transfer protocol (HTTP) POST request to a service notification management server (SNM-S). The HTTP POST request comprises at least one of a request uniform resource identifier (URI) to a URI of the SNM-S, a host header with a public user identity of the SNM-S, an authorization header field with a bearer authentication scheme, a content-type header field, and a PULL notification message triggers support indication.

According to another embodiment of the present disclosure, a service notification management server (SNM-S) for creating a notification channel with PULL notification message trigger in a service enabler architecture layer (SEAL) notification management (SNM) service is disclosed herein. The SNM-S includes a memory, a processor, and a communicator. The processor is configured to receive a hypertext transfer protocol (HTTP) POST request from a service notification management client (SNM-C) to create the notification channel with the PULL notification message trigger. The processor is further configured to detect, based on the received HTTP POST request, by the SNM-S, that the channel type is a PULL notification channel, and a value of a PULL notification message triggers support indication is assigned as true. The processor is further configured to determine whether the SNM-S supports sending a PULL notification message trigger to the SNM-C to initiate a PULL notification message procedure. The processor is further configured to send a PULL trigger support indication, in an HTTP 200 (OK) message, to the SNM-C, wherein the HTTP 200 (OK) message comprises one or more server-side parameters to create the notification channel with the PULL notification message trigger.

To further clarify the advantages and features of the present disclosure, a more particular description of the disclosure will be rendered by reference to specific embodiments thereof, which are illustrated in the appended drawings. It is appreciated that these drawings depict only typical embodiments of the disclosure and are therefore not to be considered limiting of its scope. The disclosure will be described and explained with additional specificity and detail in the accompanying drawings.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIGS. 1A and B illustrate a sequence flow diagrams of a plurality of operations for creating a PULL notification channel with “PULL trigger support” in a SEAL SNM service according to an embodiment as disclosed herein;

FIG. 2 illustrates a SNM-C for the notification channel management more specifically related to PULL notification trigger management according to an embodiment as disclosed herein;

FIG. 3 illustrates SNM-S for the notification channel management more specifically related to the PULL notification trigger management according to an embodiment as disclosed herein;

FIG. 4 illustrates a method for managing the PULL notification message trigger by the SNM-C according to an embodiment as disclosed herein; and

FIG. 5 illustrates a flow diagram of a method for managing the PULL notification message trigger by the SNM-S according to an embodiment as disclosed herein.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

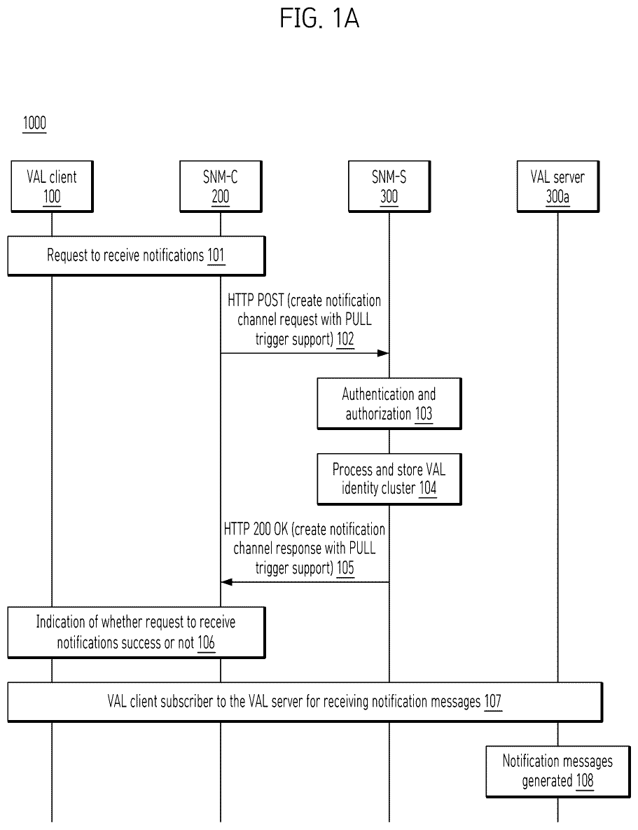

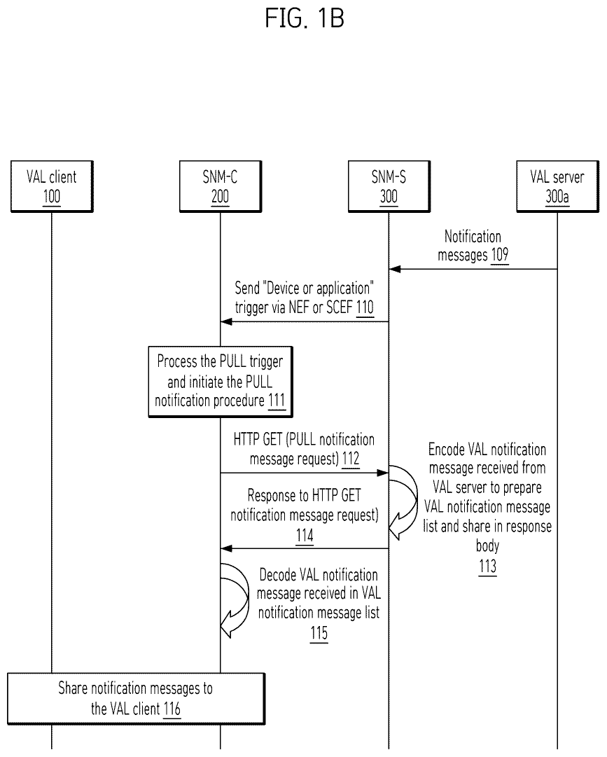

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

For the purpose of promoting an understanding of the principles of the disclosure, reference will now be made to the embodiment illustrated in the drawings and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are explanatory of the disclosure and are not intended to be restrictive thereof.

Reference throughout this specification to “an aspect,” “another aspect” or similar language means that a particular feature, structure, or characteristic described in connection with the embodiment is included in at least one embodiment of the present disclosure. Thus, appearances of the phrase “in an embodiment,” “in one embodiment,” “in another embodiment,” and similar language throughout this specification may, but do not necessarily, all refer to the same embodiment.

The terms “comprise,” “comprising,” or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks that carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

The service enabler architecture layer (SEAL) Notification management (SNM) service is a framework designed to facilitate delivery of one or more notifications in a networked environment. The SNM enables applications (e.g., vertical application layer (VAL) applications) to receive real-time notifications about events or updates relevant to users from specific servers called vertical application layer (VAL) servers. This enhances user engagement and experience within the networked environment. The SNM provides standardized procedures for managing notification subscriptions, ensuring that the applications can efficiently pull, or push notifications based on user preferences and application requirements.

For instance, a messaging application leveraging the SNM framework necessitates real-time notifications for the latest messages received from other users as they become available on the network. For another instance, a social media application leveraging the SNM framework requires timely notifications for updates such as comments and likes on users' posts, stories, or reels as they are generated on the network/other users. By integrating with various services, the SNM supports seamless communication between user devices (e.g., User Equipment (UE)) and backend systems, optimizing resource utilization and improving response times for time-sensitive information. However, several problems are encountered in the existing pull notifications, which are mentioned below.

According to the SEAL Notification management service outlined in the Third Generation Partnership Project (3GPP) Technical Specification (TS) 24.542, a SEAL Notification management client (SNM-C) associated with the UE initiates a request to a SEAL Notification management server (SNM-S) to retrieve the latest notification messages in real-time. An example of the request may include, but is not limited to, a hypertext transfer protocol (HTTP) GET request. In the existing pull notifications, when the SNM-S has no pending notification messages, the SNM-S responds immediately to the SNM-C. Subsequently, the SNM-C initiates another PULL request in response to the received message, a method referred to as “frequent polling,” Alternatively, the SNM-S may choose to hold the PULL request from the SNM-C and respond only when notification messages are available, a method known as “long polling,” This holding period can be extended significantly. Both frequent polling and long polling scenarios contribute to increased resource consumption across the UE, network, and SNM-S. The frequent polling keeps the UE active, leading to heightened network traffic due to the high frequency of PULL requests. Additionally, all “stateful” network entities must maintain a hypertext transfer protocol (HTTP) transaction in an active state during the long polling, resulting in further resource and bandwidth consumption.

Thus, it is desired to address the above-mentioned disadvantages or other shortcomings or at least provide a useful alternative for the pull notifications.

A SEAL notification management client (SNM-C) initiates a request to create a PULL notification channel with a SEAL notification management server (SNM-S). Upon successful processing of this request, the SNM-S responds with a “callback uniform resource locator (URL)” and a “notification URL,” The notification URL may be utilized by the SNM-C to retrieve notification messages from the SNM-S in the future. Additionally, one or more value added layer (VAL) applications on a user equipment (UE) can leverage this PULL notification channel by providing the callback URL associated with the SNM-S to their respective VAL servers, thereby facilitating the delivery of future notification messages through the SNM-S. Therefore, the present disclosure streamlines notification management, reducing the burden on individual VAL applications on the UE by consolidating notification handling into a single or minimal number of channels between the SNM-C and the SNM-S.

In one or more embodiments, the disclosed method and system address challenges associated with long polling or frequent polling by introducing a “device trigger” or “application trigger” mechanism linked to the PULL notification procedures. Specifically, when notification messages are received at the SNM-S intended for the SNM-C, the SNM-S may dispatch DEVICE or APPLICATION triggers to the SNM-C. Subsequently, the SNM-C may initiate an HTTP request to PULL notification messages only upon receiving these triggers from the SNM-S. This integration of the trigger mechanism as a prerequisite for the PULL notification procedures effectively mitigates overhead, allowing the SNM-C to retrieve notification messages solely when SNM-S has outstanding messages, as described in conjunction with FIG. 1A to FIG. 5. Consequently, the disclosed method and system eliminate the need for HTTP long polling or frequent polling methodologies.

In one or more embodiments, the disclosed method is established for the SNM-C to encode and decode the “pull notification message trigger” information field as part of the create notification channel procedure, as described in conjunction with FIGS. 1A-1B.

In one or more embodiments, the disclosed method is established for SNM-S to encode and decode the “pull notification message trigger” information field as part of the create notification channel procedure, as described in conjunction with FIGS. 1A-1B.

In one or more embodiments, the disclosed method enhances the existing create notification channel procedures by incorporating support for pull notification message triggers between the SNM-C and the SNM-S. A new information field, “pull notification message trigger,” is introduced to indicate both SNM-C and SNM-S support for application triggers that initiate the pull notification message procedure, as described in conjunction with FIG. 1A to FIG. 5.

Referring now to the drawings, and more particularly to FIGS. 1A to 5, where similar reference characters denote corresponding features consistently throughout the figures, there are shown preferred embodiments.

FIGS. 1A and 1B illustrate sequence flow diagrams 1000 of a plurality of operations for managing a PULL notification channel with “PULL trigger support” in a SNM service according to an embodiment as disclosed herein. In one embodiment, the SNM service utilizes various network entities, for example, a VAL client 100, an SNM-C 200, an SNM-S 300, and a VAL server 300a.

Referring to FIG. 1A, at operation 101, the SNM-C 200 may receive requests from one or more VAL client(s) (100) to receive notifications messages addressed to them from the SNM-S 300. At operation 102, upon receiving such request(s), the SNM-C 200 transmits a hypertext transfer protocol (HTTP) POST request to the SNM-S 300 to establish the PULL notification channel. The HTTP POST request may correspond to a request to create PULL notification channel with the PULL trigger support. The subsequent operations performed by the SNM-C 200 during this HTTP POST request are detailed as follows.

The SNM-C 200 sets a request-uniform resource identifier (URI) to a URI of the SNM-S 300. The SNM-C 200 includes a Host header, which contains a public user identity of the SNM-S 300. An Authorization header field may also include, utilizing the “bearer” authentication scheme as defined in Internet engineering task force (IETF) request for comments (RFC) 6750. Additionally, the SNM-C 200 may specify a content-type header field set to “application/vnd.3gpp.seal-create-notification-channel-request,” In one embodiment, the SNM-C 200 may generate HTTP POST request and/or the create notification channel request message in accordance with the specifications outlined in Table-1, incorporating parameters serialized into a JavaScript object notation (JSON) structure as per IETF RFC 7159.

TABLE 1

| Client-side | |
|---|---|
| Parameter | Description |
| Requestor identity | REQUIRED. Represents the identity of the notification management |
| | client. |
| Channel type | REQUIRED. Represents the PULL or PUSH method to be used for |
| | delivering the notification messages. |
| | 0x01: PUSH TYPE |
| | 0x02: PULL TYPE |
| PUSH channel details | OPTIONAL. Represents details of the type of PUSH delivery and its |
| | associated data as specified in table A.1.2-2 (3GPP TS 24.542 |
| | v1.1.0)). |
| Expiry time | REQUIRED. Represents the duration the notification channel may be |
| | active (i.e., channel lifetime) as requested by the notification |
| | management client. |
| Pull notification | OPTIONAL. Represents the application trigger for pulling notification |
| message trigger | messages. When set to “true,” it indicates to the SNM-S about the |
| (PULL notification | SNM-C capability to support the application trigger to initiate the pull |
| message triggers | notification message procedure. Set to “false” or omitted otherwise. |
| support indication) | (NOTE) |
| VAL Id Cluster List | REQUIRED. Represents the list of VAL identities corresponding to |
| | the VAL services as specified in table A.1.2-3 (3GPP TS 24.542 |
| | v1.1.0)). |

(NOTE):
This attribute may be provided if “Channel type” is set to PULL TYPE.

To generate the create notification channel request message, the SNM-C 200 may execute the following operations, which may relate to Table-1:
a. The SNM-C 200 may assign a requestor identity that may corresponds to the SNM-C 200;
b. The channel type is designated as either PULL or PUSH, contingent upon the VAL application's request for the notification channel;
c. If the channel type is PUSH, the SNM-C 200 populates the PUSH channel details parameter with the corresponding PUSH callback URL;
d. The SNM-C 200 specifies a validity duration for the notification channel;
e. If the channel type is PULL, and if the SNM-C 200 supports application triggers to initiate the pull notification message procedure, the pull notification message trigger parameter is set to “true,” This application trigger allows the SNM-C 200 to retrieve notification messages from the SNM-S 300 only when outstanding notification messages are available; and
f. Finally, the SNM-C 200 populates a VAL ID cluster list parameter with the identities of each VAL service that has requested to receive notifications via the notification channel.

At operation 103-104, upon receiving the HTTP POST request from the SNM-C 200, where the request-URI includes the URI of the SNM-S 300, the SNM-S 300 executes a series of operations as outlined herein. The SNM-S 300 may validate the identity of the requestor in accordance with 3GPP TS 24.542. If the identity of the requester (relates to SNM-C 200) is not recognized as an authorized user, the SNM-S 300 may issue an HTTP (forbidden) response and terminate further processing, not shown in the FIG. 1A.

If the request pertains to the creation of the notification channel, the SNM-S 300 may proceed based on the specified channel type, either PUSH or PULL.

For the PUSH channel, the SNM-S 300 may perform various operations, which are given below.
a. The SNM-S 300 may evaluate the PUSH channel details parameter as defined in clause A.1.2 to retrieve the PUSH callback-URL of the SNM-C 200:
i. If the PUSH callback-URL is absent, the SNM-S 300 may respond with an HTTP 406 (Not Acceptable) response and cease further processing;
ii. If provided, the SNM-S 300 may store the PUSH callback-URL for future notifications directed to the SNM-C 200; and
b. The SNM-S 300 may also process the VAL ID cluster list parameter, which enumerates VAL identities corresponding to each VAL service requesting notification messages through the designated channel.

For the PULL notification channel, the SNM-S 300 may perform various operations, which are given below:
a. The SNM-S 300 may process a pull notification message trigger attribute, if included. If the SNM-S 300 also supports sending the application trigger to the SNM-C 200 to initiate the pulling notification message procedure, then the SNM-S 300 may share this indication in the create notification channel response and store this for future usage to send triggers to the SNM-C 200 for outstanding notification messages received from the VAL server 300a:
i. The SNM-S 300 can leverage application-triggering services (or device triggering) offered by the 3GPP core network via network exposure function (NEF) or service capability exposure function (SCEF);
b. The SNM-S 300 may remain in a state of readiness for the SNM-C 200 to pull notification messages; and
c. The SNM-S 300 may process the validity duration shared by the SNM-C 200:
i. The SNM-S 300 may store the authorized user and information shared as part of creating notification channel requests for future references.

At operation 105, upon successful creation of the notification channel, the SNM-S 300 may perform various operations, which are given below.

The SNM-S 300 may create a notification channel response message with the below attributes as specified in Table-2. In other words, the SNM-S 300 may convey the following parameters while sending the response to the create notification channel request.

The SNM-S 300 may include a content-type header field set to “application/vnd.3gpp.seal-create-notification-channel-response,” Additionally, the SNM-S 300 may send an HTTP 200 (OK) response including the message generated above (i.e., notification channel response message).

TABLE 2

| Server-side | |
|---|---|
| Parameter | Description |
| Notification URL | OPTIONAL. Represents the URL that may be used by SNM-C to pull |
| | notifications if the channel type is PULL. |
| Callback URL | REQUIRED. Represents the URL, which may be notified to the VAL |
| | client by SNM-C. Further, this URL may be shared by the VAL client |
| | to the VAL server while subscribing for VAL services. |
| Channel Identifier | REQUIRED. Represents the identifier of the newly created |
| | notification channel. |
| Pull notification | OPTIONAL. Represents the application trigger for pulling notification |
| message trigger | messages. When set to “true,” it indicates the SNM-S is capable to |
| | send an application trigger to SNM-C to initiate the pull notification |
| | message procedure. Set to “false” or omitted otherwise. (NOTE) |
| Expiry time | OPTIONAL. Represents the duration the notification channel may be |
| | active (i.e., channel lifetime) as requested by the notification |
| | management client. |
| Notification URL | OPTIONAL. Represents the URL that may be used by SNM-C to pull |
| | notifications if the channel type is PULL. |

(NOTE):
This attribute may be provided for the PULL notification channel type.

To generate the notification channel response message with the above attributes, the SNM-S 300 may execute the following operations, which may relate to Table-2:
a. The SNM-S 300 may generate a unique channel identifier;
b. The SNM-S 300 may generate a callback URL, which may be used by the VAL clients 100 in the UE for sharing the callback URL to the VAL server 300a as part of their respective services;
c. The SNM-S 300 may generate the validity duration of the notification channel; and
d. The SNM-S 300 may generate a notification URL that may be used by the SNM-C 200 to pull the notifications from the SNM-S 300 in case of PULL channel type.

At operations 106-107, upon receiving the HTTP 200 (OK) response, the SNM-C 200 may (VAL client subscriber) notify one or more VAL services about the successful creation of the notification channel. At operation 108, consider a scenario where one or more notification messages are generated by the VAL server 300a.

Referring to FIG. 1B, at operation 109, consequently, the VAL server 300a transmits the notification messages to the SNM-S 300. At operation 110, the SNM-S 300 subsequently sends a “Device or Application” trigger via the NEF or SCEF. At operation 111, upon receipt of the trigger, the SNM-C 200 processes the PULL trigger and initiates the PULL notification procedure. At operation 112, the SNM-C 200 then issues an HTTP GET request to PULL the notification message from the SNM-S 300. At operations 113-114, in response to this request, the SNM-S 300 encodes the VAL notification messages received from the VAL server into a notification message list and transmits this list in the response body of the HTTP GET request. At operation 115, upon receiving the response, the SNM-C 200 decodes the VAL notification messages contained in the notification message list. At operation 116, the SNM-C 200 forwards the notification messages to the respective VAL client 100.

In one or more embodiments, the SNM-S 300 may send triggers to the SNM-C 200 when the SNM-S 300 has notification messages to be pulled and the SNM-C 200 may initiate an HTTP GET request to PULL the notification messages (e.g., “PULL notification messages procedure” defined in 3GPP TS 24.542) only upon receiving such trigger from the SNM-S 300 thereby avoiding the current HTTP long polling.

In one or more embodiments, the SNM-S 300 may process and wait for the SNM-C 200 to pull the notification messages. For example, the SNM-S 300 may utilize the application-triggering services (or device triggering) provided by the 3GPP core network via the NEF or the SCEF. In another example, the multiple notifications accumulated at the SNM-S 300 may be from the same VAL server towards the SNM-C 200.

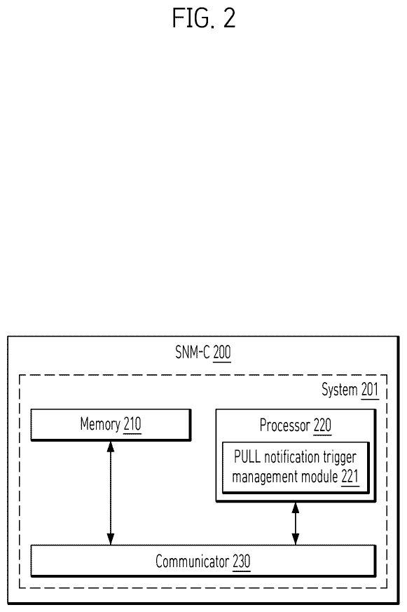

FIG. 2 illustrates a SNM-C 200 for the notification channel management more specifically related to the PULL notification trigger management according to an embodiment as disclosed herein. Examples of the SNM-C 200 include, but are not limited to, a smartphone, a tablet computer, a wearable device, etc.

In one or more embodiments, the SNM-C 200 comprises a system 201. The system 201 may include a memory 210, a processor 220, and a communicator 230.

In one or more embodiments, the memory 210 stores instructions to be executed by the processor 220 for creating the notification channel with PULL notification message trigger in the SNM service, as discussed throughout the disclosure. The memory 210 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 210 may, in some examples, be considered a non-transitory storage medium. The term “non-transitory” may indicate that the storage medium is not embodied in a carrier wave or a propagated signal. However, the term “non-transitory” should not be interpreted that the memory 210 is non-movable. In some examples, the memory 210 can be configured to store larger amounts of information than the memory. In certain examples, a non-transitory storage medium may store data that can, over time, change (e.g., in random access memory (RAM) or cache). The memory 210 can be an internal storage unit, or the memory 210 can be an external storage unit of the SNM-C 200, a cloud storage, or any other type of external storage.

In one or more embodiments, the processor 220 communicates with the memory 210, and the communicator 230. The processor 220 is configured to execute instructions stored in the memory 210 and to perform various processes for creating the notification channel with the PULL notification message trigger in the SNM service, as discussed throughout the disclosure. The processor 220 may include one or a plurality of processors, maybe a general-purpose processor, such as a central processing unit (CPU), an application processor (AP), or the like, a graphics-only processing unit such as a graphics processing unit (GPU), a visual processing unit (VPU), and/or an artificial intelligence (AI) dedicated processor such as a neural processing unit (NPU).

In one or more embodiments, the processor 220 may include a PULL notification trigger management module 221. The PULL notification trigger management module 221 is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

In one or more embodiments, the PULL Notification Trigger management module 221 is further configured to determine whether a user equipment (UE) supports the application-trigger mechanism to initiate the PULL notification message procedure. The application-trigger mechanism enables the SNM-C 200 to PULL one or more notification messages from the SNM-S 300 when one or more outstanding notifications are available at the SNM-S 300. The PULL notification trigger management module 221 is further configured to assign a value of the PULL notification message triggers support indication as true in create PULL notification channel request on determining that the UE supports the application-trigger mechanism to initiate the PULL notification message procedure.

In one or more embodiments, the HTTP POST request comprises one or more client-side parameters to create the PULL notification channel with the PULL notification message trigger, which may relate to Table-1. The one or more client-side parameters may include, for example, but not limited to, the requestor identity, the channel type, the PUSH channel details parameter, the validity duration, the PULL notification message triggers support indication, and the VAL ID cluster list.

In one or more embodiments, the PULL notification trigger management module 221 is further configured to determine if the SNM-C 200 supports receiving the application or devices trigger and encode or decode the PULL notification message triggers support indication as part of a process of creating the PULL notification channel procedure.

In one or more embodiments, the PULL notification trigger management module 221 is further configured to receive the HTTP 200 (OK) message from the SNM-S 300 in response to transmitting the HTTP POST request, which may relate to operation 105 of FIG. 1A. The HTTP 200 (OK) message may include the one or more server-side parameters to create the notification channel with the PULL notification message trigger, which may relate to Table-2. The one or more server-side parameters may include, for example, but not limited to, the notification URL, the callback URL, the channel identifier, the PULL notification message triggers support indication, and the expiry time.

In one or more embodiments, the PULL notification trigger management module 221 is further configured to monitor the PULL notification message trigger from the SNM-S.

The communicator 230 is configured for communicating internally between internal hardware components and with external devices (e.g., server) via one or more networks (e.g., radio technology). The communicator 230 includes an electronic circuit specific to a standard that enables wired or wireless communication.

Although FIG. 2 shows various hardware components of the SNM-C 200, but it is to be understood that other embodiments are not limited thereon. In other embodiments, the SNM-C 200 may include less or more number of components. Further, the labels or names of the components are used only for illustrative purpose and does not limit the scope of the disclosure. One or more components can be combined to perform the same or substantially similar functions to create the notification channel with the PULL notification message trigger in the SNM service.

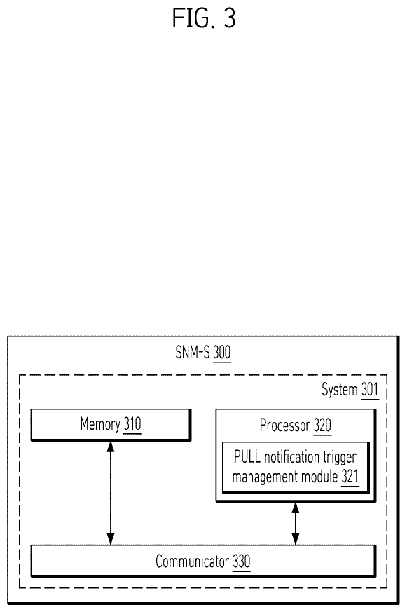

FIG. 3 illustrates a block diagram of the SNM-S 300 for the notification channel management more specifically related to the PULL notification trigger management according to an embodiment as disclosed herein.

In one or more embodiments, the SNM-S 300 comprises a system 301. The system 301 may include a memory 310, a processor 320, and a communicator 330.

In one or more embodiments, the memory 310 stores instructions to be executed by the processor 320 for managing the PULL notification message trigger in the SNM service, as discussed throughout the disclosure. The memory 310 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 310 may, in some examples, be considered a non-transitory storage medium. The term “non-transitory” may indicate that the storage medium is not embodied in a carrier wave or a propagated signal. However, the term “non-transitory” should not be interpreted that the memory 310 is non-movable. In some examples, the memory 310 can be configured to store larger amounts of information than the memory. In certain examples, a non-transitory storage medium may store data that can, over time, change (e.g., in random access memory (RAM) or cache). The memory 310 can be an internal storage unit, or the memory 310 can be an external storage unit of the SNM-S 300, a cloud storage, or any other type of external storage.

In one or more embodiments, the processor 320 communicates with the memory 310, and the communicator 330. The processor 320 is configured to execute instructions stored in the memory 310 and to perform various processes for managing the PULL notification message trigger in the SNM service, as discussed throughout the disclosure. The processor 320 may include one or a plurality of processors, maybe a general-purpose processor, such as a central processing unit (CPU), an application processor (AP), or the like, a graphics-only processing unit such as a graphics processing unit (GPU), a visual processing unit (VPU), and/or an artificial intelligence (AI) dedicated processor such as a neural processing unit (NPU).

In one or more embodiments, the processor 320 may include a PULL notification trigger management module 321. The PULL notification trigger management module 321 is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

In one or more embodiments, the PULL notification trigger management module 321 is configured to detect, the value of the PULL notification message triggers support indication is assigned as true based on the received HTTP POST request for PULL notification channel creation. The PULL notification trigger management module 321 is further configured to determine whether the SNM-S supports sending the PULL notification message trigger to the SNM-C to initiate the PULL notification message procedure. The PULL notification trigger management 321 is further configured to set the PULL trigger support indication, in the HTTP 200 (OK) message, sent to the SNM-C 200, which may relate to operation 105 of FIG. 1A. The HTTP 200 (OK) message may include the one or more server-side parameters to create the notification channel with the PULL notification message trigger, which may relate to Table-2.

In one or more embodiments, the PULL notification trigger management module 321 is further configured to store the PULL notification message trigger support indication in order to send one or more triggers to the SNM-C for any outstanding notification messages received from one or more VAL servers 300a.

In one or more embodiments, the PULL notification trigger management 321 is further configured to utilize at least one application-triggering service or at least one device-triggering service provided by a 3GPP core network via network exposure function (NEF) or service capability exposure function (SCEF) to initiate the PULL notification message trigger towards the SNM-C 200.

In one or more embodiments, the PULL notification trigger management 321 is further configured to determine if the SNM-S 300 supports sending the application or devices trigger and encode or decode the PULL notification message triggers support indication as part of a process of creating the notification channel procedure.

Although FIG. 3 shows various hardware components of the SNM-S 300, but it is to be understood that other embodiments are not limited thereon. In other embodiments, the SNM-S 300 may include less or more number of components. Further, the labels or names of the components are used only for illustrative purposes and do not limit the scope of the disclosure. One or more components can be combined to perform the same or substantially similar functions to create the notification channel with the PULL notification message trigger in the SNM service.

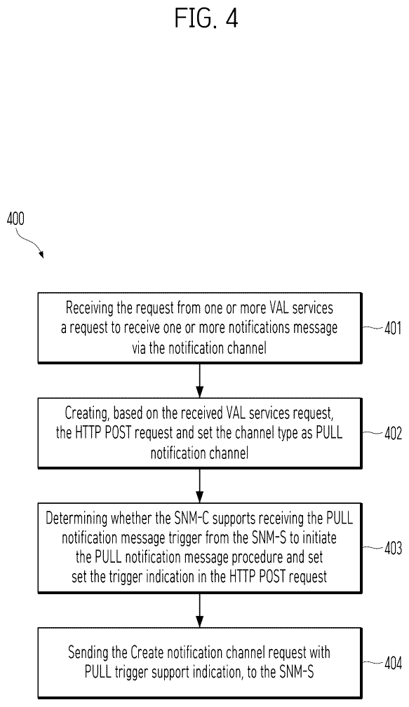

FIG. 4 illustrates a flow diagram of a method 400 for managing the PULL notification message trigger by the SNM-C 200 according to an embodiment as disclosed herein. The method 400 may execute multiple operations to create the notification channel, which are given below.

At operation 401, the method 400 includes receiving the request from one or more VAL services to receive one or more notifications via the notification channel. The method performs one or more operations to manage the PULL notification message trigger by transmitting the HTTP POST request to the SNM-S 300, which are given below.

At operation 402, the method 400 includes creating, based on the received VAL services request, the HTTP POST request and set the channel type as PULL notification channel, which may relate to operation 102. At operation 403, the method 400 includes determining whether the SNM-C 200 supports receiving the PULL notification message trigger from the SNM-S 300 to initiate the PULL notification message procedure and set the trigger indication in the HTTP POST request. At operation 404, the method 400 includes sending the create notification channel request with PULL trigger support indication, to the SNM-S 300, as described in Table-1.

In one or more embodiments, the method 400 includes configuring the bearer authentication scheme to utilize a bearer token as an access token (bearer authentication scheme). The method 400 further includes configuring the content-type header field as a specific type of application or vendor-specific extension.

In one or more embodiments, the method includes managing the PULL notification message trigger by transmitting the HTTP POST request to the SNM-S 300. The HTTP POST request comprises the one or more client-side parameters to manage the PULL notification message trigger. The one or more client-side parameters comprise the requestor identity, the channel type, the PUSH channel details parameter, the validity duration, the PULL notification message triggers support indication, and the VAL ID cluster list.

In one or more embodiments, the method 400 includes determining whether the UE supports the application-trigger mechanism to initiate the PULL notification message procedure. The method 400 further includes assigning the value of the PULL notification message triggers support indication as true in request on determining that the UE supports the application-trigger mechanism to initiate the PULL notification message procedure. The application-trigger mechanism enables the SNM-C 200 to PULL one or more notification messages from the SNM-S 300 when one or more outstanding notifications are available at the SNM-S 300.

In one or more embodiments, the method 400 includes encoding or decoding the PULL notification message triggers support indication as part of a process of managing the PULL notification message trigger.

In one or more embodiments, the method 400 includes receiving an HTTP 200 (OK) message from the SNM-S in response to transmitting the HTTP POST request, wherein the HTTP 200 (OK) message comprises one or more server-side parameters to manage the PULL notification message trigger. The method further includes notifying the one or more VAL services for successful creation of the notification channel. The method further includes monitoring the PULL notification message trigger from the SNM-S 300.

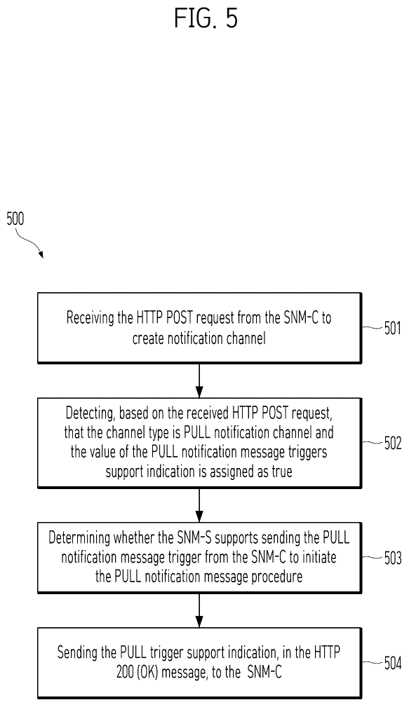

FIG. 5 illustrates a flow diagram of a method 500 for managing the PULL notification message trigger by the SNM-S 300 according to an embodiment as disclosed herein. The method 500 may execute multiple operations to manage the PULL notification message trigger, which are given below.

At operation 501, the method 500 includes receiving the HTTP POST request from the SNM-C 200 to create the notification channel. At operation 502, the method 500 includes detecting, based on the received HTTP POST request, that the channel type is the PULL notification channel and the value of the PULL notification message triggers support indication is assigned as true. At operation 503, the method 500 includes determining whether the SNM-S 300 supports sending the PULL notification message trigger to the SNM-C 200 to initiate the PULL notification message procedure. At operation 504, the method 500 includes sending the PULL trigger support indication, in the HTTP 200 (OK) message as response to the create the notification channel.

In one or more embodiments, the method 500 includes storing the PULL notification message trigger support indication in order to send one or more triggers to the SNM-C 200 for any outstanding notification messages received from one or more VAL servers 300a.

In one or more embodiments, the SNM-S 300 utilizes at least one application-triggering services or at least one device-triggering services provided by the 3GPP core network via the NEF or the SCEF to initiate the PULL notification message trigger towards the SNM-C 200.

In one or more embodiments, the one or more server-side parameters comprise the notification URL, the callback URL, the channel identifier, the PULL notification message triggers support indication, and the expiry time.

In one or more embodiments, the method 500 includes encoding or decoding the PULL notification message triggers support indication as part of the process of managing the PULL notification message trigger.

The disclosed method(s)/system(s) have several advantages over the existing method, which are stated below.
a. Standardized notification channel service: The method establishes a uniform notification channel service for the one or more VAL applications on devices (e.g., UE). This standardization simplifies the integration process for developers, as they no longer need to create custom notification systems. It ensures consistency across different applications and devices, improving interoperability.
b. Introduction of DEVICE TRIGGER and APPLICATION TRIGGER: The method introduces “DEVICE TRIGGER” and “APPLICATION TRIGGER” as essential components for initiating the PULL notification procedures. These triggers allow applications to efficiently manage when to request notifications, ensuring that they only do so when necessary, thereby optimizing performance.
c. Efficient resource usage: Applications that utilize the PULL Notification channel can retrieve user-specific messages more effectively. By leveraging the triggers, they can minimize unnecessary network requests and conserve device resources, such as battery life and data usage, leading to a better user experience.
d. Compliance with 3GPP Standards: Device and network vendors can implement this method to achieve compliance with 3GPP standards for SEAL notification management service. This compliance not only enhances credibility but also ensures that the solutions offered are up to industry standards, making them more attractive to potential users.
e. Enhanced PULL notification performance: The method allows the SNM-C 200 to pull messages from the SNM-S 300 only when relevant user-specific notifications are available on the network. This targeted approach improves the efficiency and responsiveness of notification delivery, ensuring that users receive timely and pertinent information without unnecessary delays.
f. Improved user experience: By streamlining notification processes and ensuring that only relevant messages are pulled, users benefit from a more responsive and efficient application experience. This leads to higher user satisfaction and engagement, as notifications are timely and contextually relevant.

The various actions, acts, blocks, steps, or the like in the flow/sequence diagrams may be performed in the order presented, in a different order, or simultaneously. Further, in some embodiments, some of the actions, acts, blocks, steps, or the like may be omitted, added, modified, skipped, or the like without departing from the scope of the disclosure.

Unless otherwise defined, all technical and scientific terms used herein have the same meaning as commonly understood by one ordinary skilled in the art to which this disclosure belongs. The system, methods, and examples provided herein are illustrative only and not intended to be limiting.

While specific language has been used to describe the present subject matter, any limitations arising on account thereto, are not intended. As would be apparent to a person in the art, various working modifications may be made to the method to implement the inventive concept as taught herein. The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment.

The embodiments disclosed herein can be implemented using at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a service enabler architecture layer (SEAL) notification management (SNM) client (SNM-C) in a communication system, the method comprising:
receiving, from a vertical application layer (VAL) service, a request to receive at least one notification via a notification channel;
transmitting, to an SNM server (SNM-S), a hypertext transfer protocol (HTTP) POST request comprising a create notification channel request message; and
receiving, from the SNM-S, an HTTP 200 (OK) response,
wherein the create notification channel request message comprises information on capability to support application trigger to initiate pull notification message procedure.

2. The method of claim 1, further comprising:
creating the notification channel by transmitting the HTTP POST request to the SNM-S; and
transmitting, to the VAL service, information on a successful creation of the notification channel,
wherein the HTTP POST request comprises at least one of information on uniform resource identifier (URI) of the SNM-S, information on a host header with a public user identity of the SNM-S, information on an authorization header field with a bearer authentication scheme, or information on a content-type header field.

3. The method of claim 1, wherein the HTTP 200 (OK) response comprises a create wherein the create notification channel response message comprises information on capability to send the application trigger to the SNM-C to initiate the pull notification message procedure, and
wherein the information on the capability to send the application trigger to the SNM-C to initiate the pull notification message procedure is stored in the SNM-S for future usage to send triggers to the SNM-C for outstanding notification messages received from a VAL server.

4. The method of claim 1, wherein the application trigger enables the SNM-C to pull notification messages from the SNM-S only when outstanding notifications are available at the SNM-S, and
wherein the SNM-S utilizes at least one application triggering service or at least one device triggering service provided by a core network via network exposure function (NEF) or service capability exposure function (SCEF).

5. A method performed by a service enabler architecture layer (SEAL) notification management (SNM) server (SNM-S) in a communication system, the method comprising:
receiving, from an SNM client (SNM-C), a hypertext transfer protocol (HTTP) POST request comprising a create notification channel request message; and
transmitting, to the SNM-C, an HTTP 200 (OK) response,
wherein the create notification channel request message comprises information on capability to support application trigger to initiate pull notification message procedure.

6. The method of claim 5, wherein a notification channel is created by SNM-C,
wherein the HTTP POST request comprises at least one of information on uniform resource identifier (URI) of the SNM-S, information on a host header with a public user identity of the SNM-S, information on an authorization header field with a bearer authentication scheme, or information on a content-type header field,
wherein the HTTP 200 (OK) response comprises a create notification channel response message,
wherein the create notification channel response message comprises information on capability to send the application trigger to the SNM-C to initiate the pull notification message procedure, and
wherein the information on the capability to send the application trigger to the SNM-C to initiate the pull notification message procedure is stored in the SNM-S for future usage to send triggers to the SNM-C for outstanding notification messages received from a vertical application layer (VAL) server.

7. The method of claim 5, further comprising:
utilizing at least one application triggering service or at least one device triggering service provided by a core network via network exposure function (NEF) or service capability exposure function (SCEF),
wherein the application trigger enables the SNM-C to pull notification messages from the SNM-S only when outstanding notifications are available at the SNM-S.

8. A service enabler architecture layer (SEAL) notification management (SNM) client (SNM-C) in a communication system, the SNM-C comprising:
a transceiver; and
at least one processor coupled with the transceiver and configured to:
receive, from a vertical application layer (VAL) service, a request to receive at least one notification via a notification channel,
transmit, to an SNM server (SNM-S), a hypertext transfer protocol (HTTP) POST request comprising a create notification channel request message, and
receive, from the SNM-S, an HTTP 200 (OK) response,
wherein the create notification channel request message comprises information on capability to support application trigger to initiate pull notification message procedure.

9. The SNM-C of claim 8, wherein the at least one processor is further configured to:
create the notification channel by transmitting the HTTP POST request to the SNM-S, and transmit, to the VAL service, information on a successful creation of the notification channel,
wherein the HTTP POST request comprises at least one of information on uniform resource identifier (URI) of the SNM-S, information on a host header with a public user identity of the SNM-S, information on an authorization header field with a bearer authentication scheme, or information on a content-type header field.

10. The SNM-C of claim 8, wherein the HTTP 200 (OK) response comprises a create notification channel response messgae,
wherein the create notification channel response message comprises information on capability to send the application trigger to the SNM-C to initiate the pull notification message procedure, and
wherein the information on the capability to send the application trigger to the SNM-C to initiate the pull notification message procedure is stored in the SNM-S for future usage to send triggers to the SNM-C for outstanding notification messages received from a VAL server.

11. The SNM-C of claim 8, wherein the application trigger enables the SNM-C to pull notification messages from the SNM-S only when outstanding notifications are available at the SNM-S, and
wherein the SNM-S utilizes at least one application triggering service or at least one device triggering service provided by a core network via network exposure function (NEF) or service

12. A service enabler architecture layer (SEAL) notification management (SNM) server (SNM-S) in a communication system, the SNM-S comprising:
a transceiver; and
at least one processor coupled with the transceiver and configured to:
receive, from an SNM client (SNM-C), a hypertext transfer protocol (HTTP) POST request comprising a create notification channel request message, and
transmit, to the SNM-C, an HTTP 200 (OK) response,
wherein the create notification channel request message comprises information on capability to support application trigger to initiate pull notification message procedure.

13. The SNM-S of claim 12, wherein a notification channel is created by SNM-C, and
wherein the HTTP POST request comprises at least one of information on uniform resource identifier (URI) of the SNM-S, information on a host header with a public user identity of the SNM-S, information on an authorization header field with a bearer authentication scheme, or information on a content-type header field.

14. The SNM-S of claim 12, wherein the HTTP 200 (OK) response comprises a create notification channel response message,
wherein the create notification channel response message comprises information on capability to send the application trigger to the SNM-C to initiate the pull notification message procedure, and
wherein the information on the capability to send the application trigger to the SNM-C to initiate the pull notification message procedure is stored in the SNM-S for future usage to send triggers to the SNM-C for outstanding notification messages received from a vertical application layer (VAL) server.

15. The SNM-S of claim 12, wherein the at least one processor is further configured to:
utilize at least one application triggering service or at least one device triggering service provided by a core network via network exposure function (NEF) or service capability exposure function (SCEF),
wherein the application trigger enables the SNM-C to pull notification messages from the SNM-S only when outstanding notifications are available at the SNM-S.
